(19) United States
(12) Patent Application Publication
(10) Pub. No.: US 2025/0229408 A1
(43) Pub. Date: Jul. 17, 2025

(54) VACUUM-ADHESION ATTACHMENT FOR POWER TOOL AND POWER-TOOL SYSTEM

(71) Applicant: MAKITA CORPORATION, ANJO-SHI (JP)

(72) Inventors: Shun OKAMURA, Anjo-Shi (JP); Masahiro WATANABE, Anjo-Shi (JP); Tetsuya SHIMOOKA, Anjo-Shi (JP); Yuki KAWAI, Anjo-Shi (JP)

(21) Appl. No.: 18/973,454

(22) Filed: Dec. 9, 2024

(30) Foreign Application Priority Data
Jan. 11, 2024 (JP) 2024-002876

(51) Int. Cl. B25H 1/00; B25B 11/00; B25F 5/02

(52) U.S. Cl. CPC B25H 1/0057; B25B 11/007; B25F 5/02

(57) ABSTRACT

A vacuum-adhesion attachment for a power tool includes an attachment main body, a vacuum pump, a suction part, and a valve. The attachment main body is detachably mountable on a tool main body of the power tool and houses the vacuum pump. The suction part has a chamber in fluid communication with the vacuum pump and is configured to be adhered to a surface of a work material in response to the chamber being brought to a reduced pressure state by driving of the vacuum pump. The valve is in fluid communication with the chamber of the suction part. The valve, which is normally in a closed state to block a flow of outside air into the chamber, is configured to be manually switched by a user to an open state that permits a flow of outside air into the chamber.

### CROSS-REFERENCE

The present application claims priority Japanese patent application serial number 2024-002876 filed on Jan. 11, 2024, the contents of which are incorporated herein by reference.

### TECHNICAL FIELD

The present disclosure relates to a vacuum-adhesion attachment for a power tool, and to a power-tool system that includes a power tool and the vacuum-adhesion attachment.

### BACKGROUND ART

When a user holds a drill tool (e.g., a hammer drill) while pressing a tool accessory against a work material to perform drilling work using the drill tool, it leads to fatigue due to the weight and vibrations generated by the drill tool. Accordingly, a known self-holding-type drill system is configured such that it is pressed against the work material using vacuum adhesion (e.g., see U.S. Pat. No. 11,167,396).

### SUMMARY OF THE INVENTION

The known drill system described above is an apparatus in which a drill assembly, a vacuum gripping base, and an air pump, which extracts air from the vacuum gripping base, are integrated. This drill system, however, has room for improvement from the viewpoint of improving convenience.

Therefore, one non-limiting object of the present disclosure is to provide an improvement in techniques that use vacuum adhesion to hold a power tool against a work material.

According to one non-limiting aspect of the present disclosure, a vacuum-adhesion attachment for a power tool comprises an attachment main body, a vacuum pump, a suction part, and a valve. The attachment main body is configured to be mounted on a tool main body of the power tool in a detachable manner. The vacuum pump is housed in the attachment main body. The suction part has a chamber, which is in fluid communication with the vacuum pump. The suction part is configured to be adhered to a surface of a work material when the chamber is brought to a vacuum (reduced pressure) state by driving of the vacuum pump. The valve is configured to be in fluid communication with the chamber of the suction part. The valve, which is normally in a closed state to inhibit (block) a flow of outside air into the chamber, is configured to be switched, in response to manual manipulation by a user, to an open state that permits a flow of outside air into the chamber.

The vacuum-adhesion attachment of the present aspect, which is an apparatus that is separate from the power tool, can be mounted in a detachable manner on the tool main body of the power tool and integrated with the power tool. Accordingly, when the vacuum-adhesion attachment is fixed to the work material by vacuum adhesion, the tool main body of the power tool is also held in at least substantially the same position relative to the work material. Thereby, this configuration can contribute to reducing user fatigue because only a small holding force is needed by the user to hold the power tool, as compared with a situation in which a vacuum-adhesion attachment is not used. In addition, because the user can mount the vacuum-adhesion attachment on the power tool and use it only in situations needed, convenience for the user is improved.

According to another non-limiting aspect of the present disclosure, a power-tool system comprising a power tool and a vacuum-adhesion attachment is provided. The power tool comprises a motor, a tool main body, and a main switch. The tool main body houses the motor. The main switch is configured to operate in response to manual manipulation thereof for controlling starting and stopping of driving of the motor. The vacuum-adhesion attachment comprises an attachment main body, a vacuum pump, a suction part, and a valve. The attachment main body is mounted on the tool main body in a detachable manner. The vacuum pump is housed in the attachment main body. The suction part has a chamber in fluid communication with the vacuum pump and is configured to be adhered to a surface of a work material when the chamber is brought to a vacuum (reduced pressure) state by driving of the vacuum pump. The valve is in fluid communication with the chamber of the suction part. The valve, which is normally in a closed state to inhibit (block) a flow of outside air into the chamber, is configured to be switched, in response to manual manipulation by a user, to an open state that permits a flow of outside air into the chamber.

The power-tool system of the present aspect comprises: the power tool; and a vacuum-adhesion attachment, which is an apparatus that is separate from the power tool, is mounted in a detachable manner on the tool main body of the power tool, and is integrated with the power tool. Accordingly, when the suction part is fixed to the work material by vacuum adhesion, the entire power-tool system is fixed to the work material. Thereby, this configuration can also contribute to reducing user fatigue because only a small holding force is needed by the user to hold the power tool, as compared with a situation in which a vacuum-adhesion attachment is not used. In addition, because the user can mount the vacuum-adhesion attachment on the power tool and use it as the power-tool system only in situations needed, convenience for the user is improved.

### BRIEF DESCRIPTION OF THE DRAWINGS

FIG. 1 is an oblique view of a power-tool system of the present teachings.

FIG. 2 is a cross-sectional view of the power-tool system.

FIG. 3 is an oblique view of a vacuum-adhesion attachment of the present teachings.

FIG. 4 is a cross-sectional view of the vacuum-adhesion attachment.

FIG. 5 is a partial, enlarged view of FIG. 4.

FIG. 6 is a cross-sectional view taken along line VI-VI in FIG. 5.

FIG. 7 is an oblique view of the vacuum-adhesion attachment in the state in which a left-half portion and a sliding part of an attachment main body have been removed.

FIG. 8 is another partial, enlarged view of FIG. 4.

### DETAILED DESCRIPTION OF THE INVENTION

In one non-limiting embodiment of the present disclosure, the vacuum-adhesion attachment may further comprise a pump switch configured to be manually manipulated to control starting and stopping of driving of the vacuum pump. According to this embodiment, the user can cause the vacuum-adhesion attachment and a power tool to be fixed to the work material or to be released from the work material at desired timings by manually manipulating the pump switch.

In addition or in the alternative to the above-mentioned embodiment(s), the vacuum-adhesion attachment may further comprise a pressure sensor configured to measure the pressure in the chamber of the suction part or the pressure in the interior of a suction path. The suction path is a passageway that fluidly connects the chamber and the vacuum pump. According to this embodiment, information pertaining to the measured pressure can be utilized effectively to improve the function of the vacuum-adhesion attachment.

In addition or in the alternative to the above-mentioned embodiment(s), the vacuum-adhesion attachment may further comprise a control apparatus configured to control operation of the vacuum-adhesion attachment based on the pressure measured by the pressure sensor. The control apparatus may be configured to stop driving of the vacuum pump in response to the pressure falling below a first threshold during driving of the pump, and thereafter to resume driving of the vacuum pump in response to the pressure exceeding (rising above) a second threshold that is greater than the first threshold. According to this embodiment, a fixed state of the vacuum-adhesion attachment and the power tool can be maintained, even while driving of the vacuum pump is suspended, by setting the first threshold and the second threshold to appropriate values. Accordingly, electric-power consumption can be curtailed compared with an embodiment in which the vacuum pump continues to be driven while the pressure is between the first and second thresholds. It is noted that the control apparatus can comprise, for example, at least one processor (processing circuit or microprocessor(s)) and at least one memory.

In addition or in the alternative to the above-mentioned embodiment(s), the vacuum-adhesion attachment may further comprise a reporting (notification) part configured to report information indicating the state of the vacuum-adhesion attachment, such as the pressure within the chamber. According to this embodiment, the user can perceive the state of the vacuum-adhesion attachment from the information reported by the reporting part and take appropriate measures, as necessary. It is noted that the reporting part may use any method to report information. For example, the reporting part can be configured as one or more LEDs that report(s) information using light, a buzzer that reports information using sound, or a display that displays text and/or symbols.

In addition or in the alternative to the above-mentioned embodiment(s), the reporting part may be configured to report prescribed information in the situation in which the state in which a pressure exceeding the second threshold has continued for a prescribed time or in the situation in which the state in which a pressure exceeding the second threshold has occurred for a prescribed count within a prescribed time period. According to this embodiment, the user can perceive that the fixed state of the vacuum-adhesion attachment and the power tool has weakened, and therefore can, for example, manually hold the power tool with a greater force.

In addition or in the alternative to the above-mentioned embodiment(s), the vacuum-adhesion attachment may further comprise a sliding part, which is coupled to the suction part and is supported on the attachment main body so as to be slidable relative to the attachment main body in a first direction. According to this embodiment, as the power tool moves relative to the work material in accordance with the progressing of the processing work, the attachment main body, which is mounted on the tool main body, can be caused to move smoothly together with the tool main body relative to the suction part, which is fixed to the work material.

In the above-mentioned embodiment, the sliding part may comprise a first sliding member, which is supported on the attachment main body, and a second sliding member, which is coupled to the suction part and is supported on the first sliding member so as to be slidable relative to the first sliding member in the first direction. The attachment main body and the first sliding member may be configured so that a support position of the first sliding member in the first direction is changeable by the attachment main body. According to this embodiment, the suction part can be disposed at an appropriate position by, for example, changing the support position of the first sliding member in accordance with an initial position of the power tool relative to the work material.

In addition or in the alternative to the above-mentioned embodiment(s), the vacuum-adhesion attachment may further comprise a filter, which is disposed along (in) the suction path that fluidly connects the chamber and the vacuum pump. According to this embodiment, dust is less likely to enter the vacuum pump because the filter traps the dust.

In addition or in the alternative to the above-mentioned embodiment(s), a valve may be in fluid communication with the chamber via the suction path. The filter may be disposed so that outside air, which flows into the chamber via the suction path when the valve is in an open state, passes through the filter. According to this embodiment, dust adhered to the filter can be blown away by the air that flows into the chamber when the valve is in the open state.

In addition or in the alternative to the above-mentioned embodiment(s), the power tool may comprise a first terminal part, and the vacuum-adhesion attachment may comprise a second terminal part. The first terminal part and the second terminal part may be configured to be electrically connected to each other in response to the attachment main body being mounted on the tool main body. The vacuum pump may be configured to be driven by electric power supplied from the power tool via the first terminal part and the second terminal part. According to this embodiment, the configuration of the vacuum-adhesion attachment can be simplified because there is no need to provide the vacuum-adhesion attachment with an electric-power supply.

In addition or in the alternative to the above-mentioned embodiment(s), the power-tool system may further comprise a control apparatus configured to control the operation of at least one of the power tool and the vacuum-adhesion attachment in accordance with the state of the power-tool system. According to this embodiment, the convenience of the power-tool system is further improved. It is noted that the control apparatus can comprise, for example, at least one processor (processing circuit or microprocessor(s)) and at least one memory. It is noted that the control apparatus may be provided in the power tool or may be provided in the vacuum-adhesion attachment. In an embodiment in which the control apparatus comprises a plurality of processors (processing circuits or microprocessors), at least one of the processors may be provided in the power tool, and at least one of the processors may be provided in the vacuum-adhesion attachment.

In addition or in the alternative to the above-mentioned embodiment(s), the control apparatus of the power-tool system may be configured to start driving of the vacuum pump in response to the main switch of the power tool being turned ON. According to this embodiment, the user can cause driving of the motor of the power tool and driving of the vacuum pump of the vacuum-adhesion attachment to start by merely manually manipulating the main switch of the power tool to turn it ON.

In addition or in the alternative to the above-mentioned embodiment(s), the control apparatus of the power-tool system may be configured to start driving of the vacuum pump in response to the main switch of the power tool being turned ON and to start driving of the motor of the power tool after a prescribed time has elapsed since the start of driving of the vacuum pump. According to this embodiment, because the motor of the power tool is driven after the suction part begins to adhere to the work material, it becomes possible for the user to reduce the manual force, at an earlier stage, for holding the power tool against the work material.

In addition or in the alternative to the above-mentioned embodiment(s), the vacuum-adhesion attachment of the power-tool system may further comprise a pressure sensor configured to measure the pressure in the chamber of the suction part or the pressure in the interior of a suction path. As was noted above, the suction path is a passageway that fluidly connects the chamber and the vacuum pump. The control apparatus of the power-tool system may be configured to control the operation of at least one of the power tool and the vacuum-adhesion attachment based on the pressure measured by the pressure sensor. According to this embodiment, the control apparatus can effectively utilize the information pertaining to the measured pressure to perform appropriate control, thereby improving the function of the power-tool system.

In addition or in the alternative to the above-mentioned embodiment(s), the control apparatus of the power-tool system may be configured to start driving of the vacuum pump in response to the main switch of the power tool being turned ON and to start driving of the motor of the power tool in response to the pressure measured by the pressure sensor falling below a first threshold. According to this embodiment, by setting the first threshold to an appropriate value, it becomes possible to start driving of the motor of the power tool only after the suction part is securely fixed to the work material.

In addition or in the alternative to the above-mentioned embodiment(s), the control apparatus of the power-tool system may be configured to stop driving of the vacuum pump in response to the pressure falling below the first threshold during driving of the pump and thereafter to resume driving of the vacuum pump in response to the pressure exceeding (rising above) a second threshold, which is greater than the first threshold. According to this embodiment, electric-power consumption can be curtailed compared with an embodiment in which the vacuum pump continues to be driven while the pressure is between the first and second thresholds.

In addition or in the alternative to the above-mentioned embodiment(s), the control apparatus of the power-tool system may be configured to stop driving of the motor of the power tool in the situation in which the state in which a pressure exceeding the second threshold has continued for a prescribed time period or in the situation in which the state in which a pressure exceeding the second threshold has occurred for a prescribed count within a prescribed time period. According to this embodiment, it is possible to avoid the situation in which processing work is performed in the state in which the power-tool system is not securely fixed to the work material, which would decrease processing accuracy.

In addition or in the alternative to the above-mentioned embodiment(s), the power-tool system may further comprise at least one reporting (notifying) part configured to report information indicating the state of the vacuum-adhesion attachment. The reporting part may be configured, e.g., to report prescribed information in the situation in which the state in which a pressure exceeding the second threshold has continued for a prescribed time period or the situation in which the state in which a pressure exceeding the second threshold has occurred for a prescribed count within a prescribed time period. According to this embodiment, the user can perceive that the fixed state of the vacuum-adhesion attachment and the power tool has weakened, and therefore can, for example, manually hold the power tool against the work material with a greater force. It is noted that the reporting part(s) may be provided on the power tool and/or may be provided on the vacuum-adhesion attachment.

In addition or in the alternative to the above-mentioned embodiment(s), the power tool of the power-tool system may be a drill tool (e.g., a hammer drill, a driver-drill, a rotary hammer, etc.) configured to rotationally drive a tool accessory around a drive axis. The vacuum-adhesion attachment may further comprise a sliding part, which is coupled to the suction part and is supported on the attachment main body so as to be slidable relative to the attachment main body in a first direction, which is parallel to the drive axis. According to this embodiment, as the drill tool moves along the drive axis so as to approach the work material in accordance with the progressing of the drilling work by the drill tool, the attachment main body, which is mounted on the tool main body, can be caused to move smoothly together with the tool main body relative to the suction part, which is fixed to the work material.

### First Embodiment

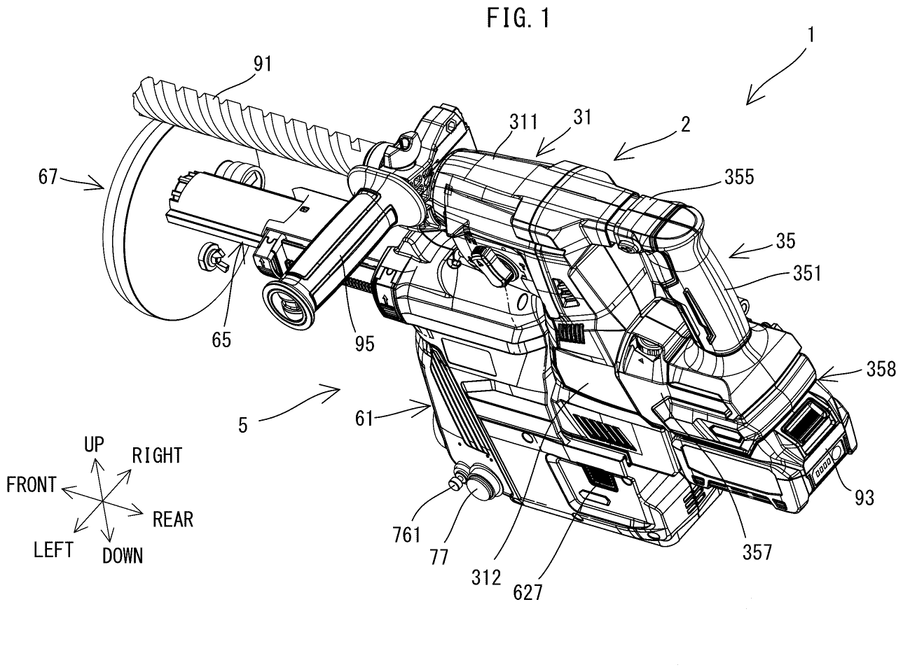

A power-tool system 1 according to a first embodiment is explained below with reference to FIG. 1 through FIG. 8.

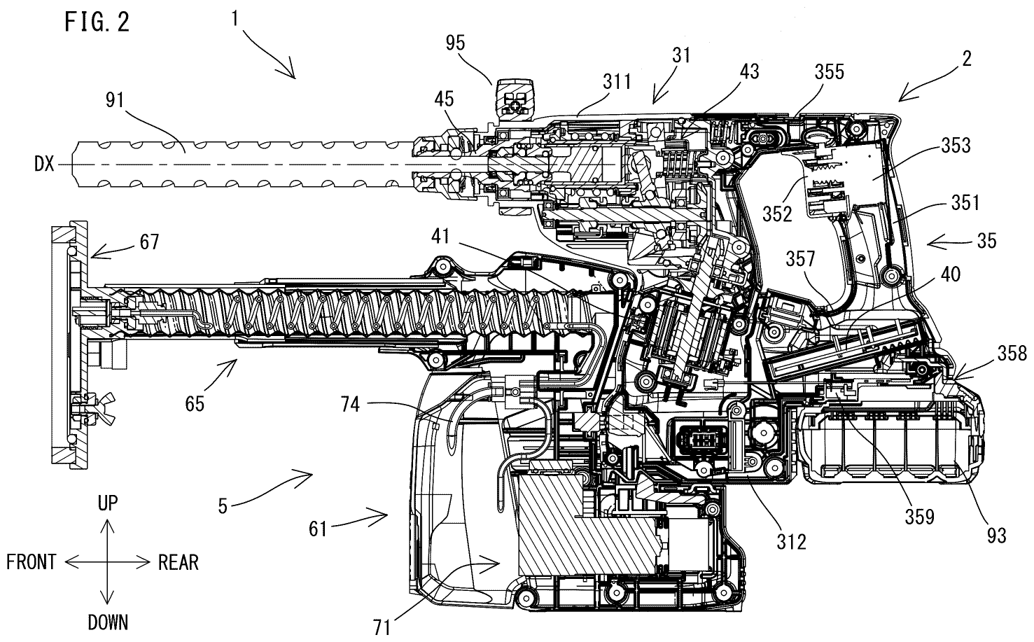

As shown in FIG. 1 and FIG. 2, the power-tool system 1 comprises a hammer drill 2 and a vacuum-adhesion attachment 5, which is mounted on the hammer drill 2 in a detachable manner. The hammer drill 2 is one representative, non-limiting example of a power tool according to the present teachings. In greater detail, the hammer drill 2 is one example of an impact (hammer) tool that is capable of performing chipping work by impacting (hammering) a tool accessory 91 to drive the tool accessory 91 linearly (reciprocally) along drive axis DX. In addition, the hammer drill 2 is one example of a drill tool that is capable of rotationally driving the tool accessory around drive axis DX to perform drilling work. The vacuum-adhesion attachment 5, which is mounted on a tool main body 31 of the hammer drill 2 in a detachable manner, is configured to fix the entire power-tool system 1 (i.e., the hammer drill 2 and the vacuum-adhesion attachment 5) to the work material using vacuum adhesion. The power-tool system 1 can perform processing work using the hammer drill 2 in the state in which the work material is fixed thereto; therefore, the power-tool system 1 can reduce the burden on the user to hold the hammer drill 2.

The particular configuration of the power-tool system 1 will be explained below.

First, the hammer drill 2 will be described. As shown in FIG. 1 and FIG. 2, the outer wall of the hammer drill 2 is formed by the tool main body 31 and a handle part 35, which is coupled to the tool main body 31.

The tool main body 31 is a hollow body that is also called a main-body housing. The tool main body 31 of the present embodiment is substantially L-shaped and includes a first portion 311, which extends along drive axis DX, and a second portion 312, which extends from one end portion of the first portion 311 in a direction that intersects with drive axis DX.

The tool main body 31 houses a tool holder 45, an electrically-driven-type motor 41, and a drive mechanism 43. The tool holder 45 is configured to hold the tool accessory 91 in a detachable manner. The drive mechanism 43 is operably coupled to the motor 41 and is configured to drive the tool accessory 91 using motive power generated by the motor 41.

In greater detail, the tool holder 45 is disposed in the interior of one end portion of the first portion 311 in the extension direction of drive axis DX. This one end portion is substantially circular-tube shaped and is also called a barrel part. An auxiliary handle (also called a side grip) 95, which is configured to be gripped by the user, is detachable from the barrel part. A majority of the drive mechanism 43 is disposed in the interior of the first portion 311. A majority of the motor 41 is disposed in the interior of the second portion 312. The motor 41 is disposed so that the rotational axis of the output shaft of the motor 41 extends in a direction that intersects with drive axis DX. The drive mechanism 43 drives the tool accessory 91 in accordance with an action mode, which is selected from among a plurality of action modes (e.g., rotation with impact mode (hammer drilling mode), rotation-only mode (drilling mode), impact-only mode (hammering mode)) of the hammer drill 2 by a manually manipulatable member that is used for selecting the action mode. Configurations of the drive mechanism 43 are well known, and therefore illustrations and explanations of a detailed configuration of the drive mechanism 43 are omitted.

The tool main body 31 is provided with a physical-coupling structure and an electrical-connection structure for attachment to the hammer drill 2, and these points will be explained in detail below.

The handle part 35 is, in its entirety, a hollow body formed into a substantially U-shape. Each end of the handle part 35 is coupled to the tool main body 31 at an end portion thereof, which is on the opposite side of the end at which the tool holder 45 is disposed, in the extension direction of drive axis DX. Thus, the handle part 35 and the tool main body 31 together form a loop shape. The handle part 35 includes a grip part 351 that is configured to be gripped by the user. The grip part 351 extends away from the tool main body 31 in a direction that intersects drive axis DX (in detail, in a direction substantially orthogonal thereto).

It is noted that, hereinbelow, for the sake of convenience, the extension direction of drive axis DX is defined as the front-rear direction of the hammer drill 2. In the front-rear direction, the side on which the tool holder 45 is located is defined as the front side of the hammer drill 2, and the opposite side (the side on which the handle part 35 is located) is defined as the rear side of the hammer drill 2. In addition, a direction that is orthogonal to drive axis DX and corresponds to substantially the extension direction of the grip part 351 is defined as the up-down direction of the hammer drill 2. In the up-down direction, the direction from the second portion 312 toward the first portion 311 is defined as the upward direction, and the direction from the first portion 311 toward the second portion 312 is defined as the downward direction. In addition, the direction orthogonal to both the front-rear direction and the up-down direction is defined as the left-right direction of the hammer drill 2.

A trigger (also called a switch lever) 352, which is configured to be pressed by the user, is disposed on (at) an upper-end portion of the grip part 351. In addition, a trigger switch 353 is housed in the interior of the grip part 351. The trigger switch 353 is normally OFF and is switched ON in response to the trigger 352 being pressed. The trigger switch 353 is electrically connected to a controller 40, which is described below.

In addition, the handle part 35 comprises an upper-side coupling part 355 and a lower-side coupling part 357. The upper-side coupling part 355 couples the upper end of the grip part 351 and a rear-end portion of the tool main body 31 (in detail, the first portion 311). The lower-side coupling part 357 couples the lower end of the grip part 351 and a rear-end portion of the tool main body 31 (in detail, the second portion 312).

The controller 40 is housed in the lower-side coupling part 357. The controller 40 is a control apparatus that controls the operation of the hammer drill 2. In the present embodiment, the controller 40 is constituted by a microcomputer or microcomputers that include(s) a CPU or CPUs, ROM, RAM, etc. However, the controller 40 may be constituted by a different type of processor or processing circuit (e.g., an ASIC (application-specific integrated circuit), or an FPGA (field-programmable gate array)) and memory. The controller 40 controls the operation of the hammer drill 2 (e.g., driving of the motor 41) based on a signal from the trigger switch 353 or the like.

In addition, a battery-mount part 358 is provided on the lower-side coupling part 357. The battery-mount part 358 is configured to receive a rechargeable battery (also called a battery pack or battery cartridge) 93 in a detachable manner. Although a detailed illustration and explanation are omitted because the configuration of a battery-mount part is well known, the battery-mount part 358 comprises rails, which are engageable with the battery 93, and a terminal part (e.g., a terminal block) 359, which is electrically connectable to a terminal part of the battery 93. When the battery 93 is mounted on the battery-mount part 358, the terminal part of the battery-mount part 358 supplies electric power from the battery 93 to each part of the hammer drill 2 (e.g., the controller 40 and the motor 41) via a terminal part (e.g., a terminal block) 359.

The vacuum-adhesion attachment 5 is explained below. It is noted that, in the explanation below, the direction of the vacuum-adhesion attachment 5 is defined with reference to the direction of the hammer drill 2 when the vacuum-adhesion attachment 5 is mounted on the hammer drill 2 as shown in FIG. 1 and FIG. 2.

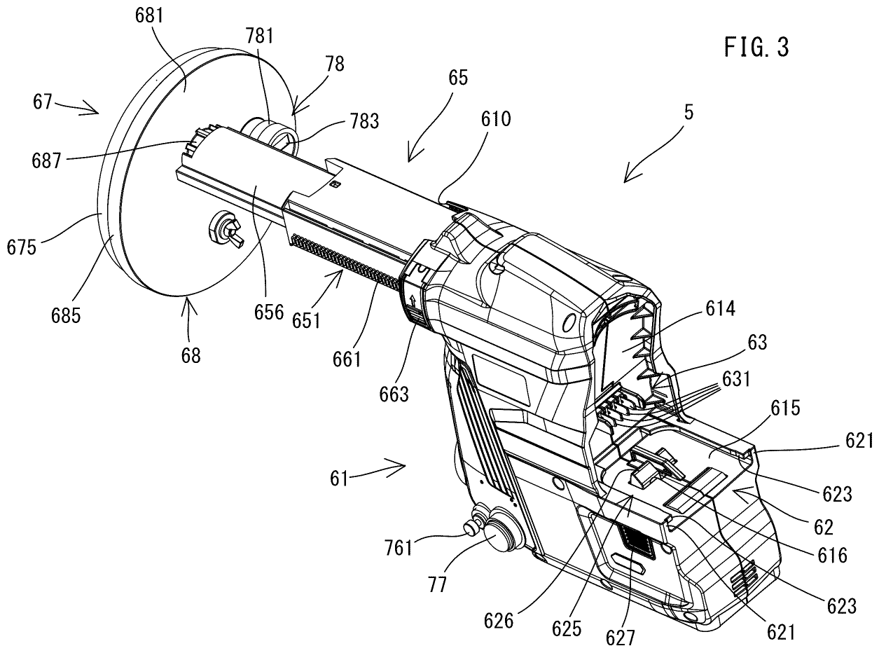

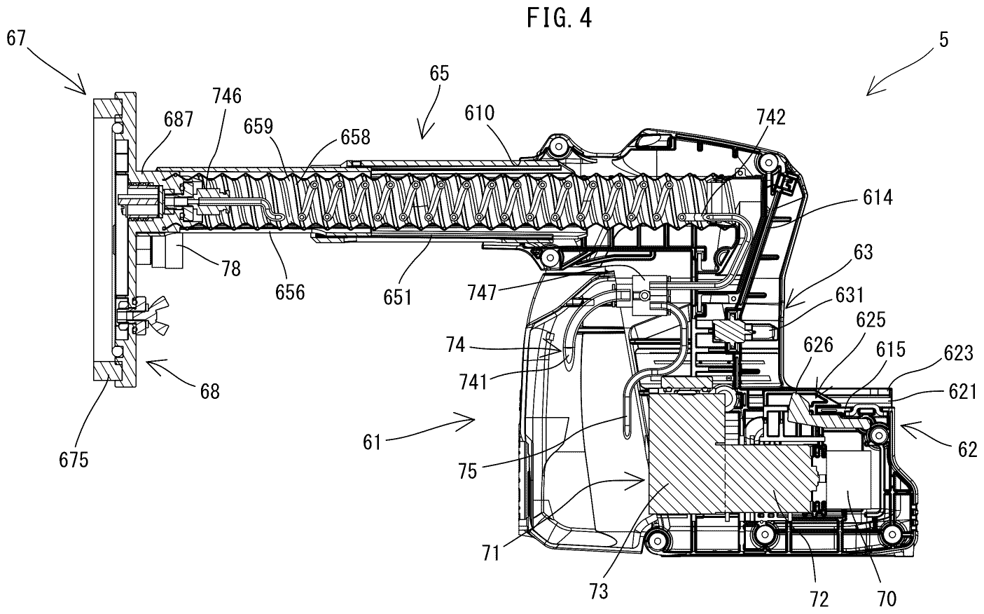

As shown in FIG. 3 and FIG. 4, the outer wall of the vacuum-adhesion attachment 5 is formed by an attachment main body 61, a sliding part 65, and a suction part 67.

A configuration of the attachment main body 61 and the structural elements disposed in the interior of the attachment main body 61 are explained below.

The attachment main body 61 is a box-shaped hollow body. The attachment main body 61 is formed to have substantially an L-shape in side view. In the present embodiment, the attachment main body 61 is formed by coupling a left-half portion (also referred to as a left-side seal) and a right-half portion (also referred to as a right-side seal) to each other in the left-right direction. The attachment main body 61 has two wall parts (a first wall part that faces rearward and a second wall part that faces upward) that correspond to the contour of the inner side of the L shape. Below, of the two above-mentioned wall parts of the attachment main body 61, the first wall part (first surface) that faces rearward is called a first opposing wall 614, and the second wall part (second surface) that faces upward is called a second opposing wall 615.

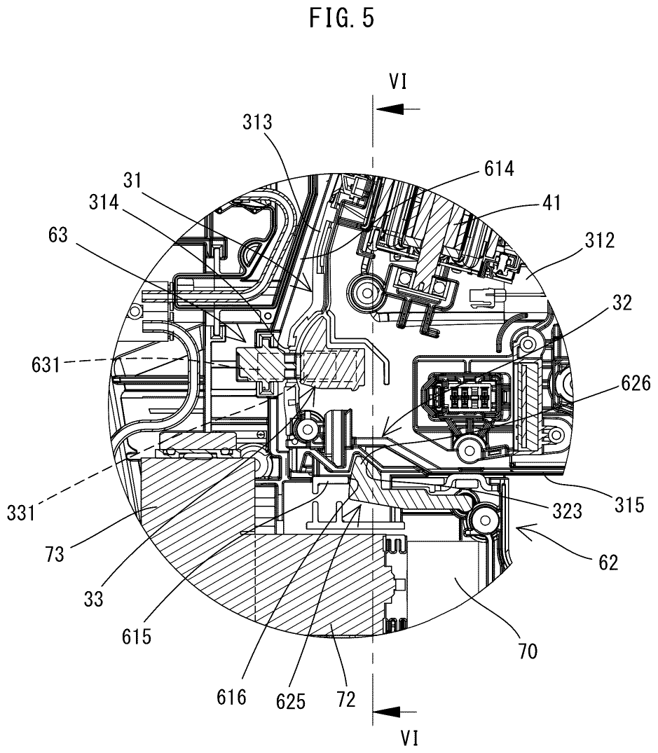

The attachment main body 61 is configured to be mounted on (coupled to) the tool main body 31 of the hammer drill 2 in a detachable manner. In greater detail, as shown in FIG. 5, the first opposing wall 614 and the second opposing wall 615 are each configured to match a portion of a front-wall part 313 and a portion of a lower-wall part 315, respectively, of the second portion 312 of the tool main body 31 of the hammer drill 2. The attachment main body 61 is mountable on the tool main body 31 so that the first opposing wall 614 and the second opposing wall 615 each oppose the front-wall part 313 and the lower-wall part 315, respectively, of the second portion 312 of the tool main body 31.

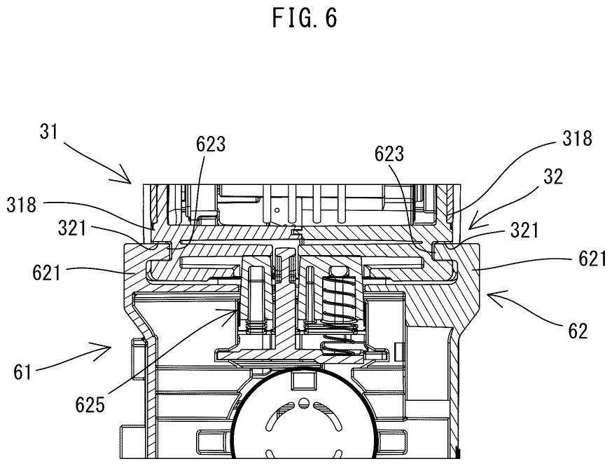

Specifically, the tool main body 31 and the attachment main body 61 are mutually coupled by mechanical engagement of a first engaging part 32 of the tool main body 31 and a second engaging part 62 of the attachment main body 61. The second engaging part 62 comprises a pair of (i.e., two) rails 623 and a locking member 625. As shown in FIG. 5 and FIG. 6, the first engaging part 32 comprises a pair of (i.e., two) grooves 321, which are engageable with the pair of (i.e., two) rails 623, and a recessed portion 323, which is capable of mating with the locking member 625.

As shown in FIG. 3 and FIG. 6, the two rails 623 of the second engaging part 62 are mutually parallel and extend linearly in the front-rear direction. In greater detail, the attachment main body 61 has sidewall parts 621 that protrude upward from the left end and the right end, respectively, of the second opposing wall 615. The two rails 623 protrude in directions approaching each other from the upper end of the left sidewall part 621 and the right sidewall part 621, and extend forward from the rear end thereof.

On the other hand, the grooves 321 of the first engaging part 32 are formed on the lower-end portion of a left sidewall part 318 and a right sidewall part 318 of the second portion 312 of the tool main body 31. The two grooves 321 extend rearward linearly and parallel to each other from the front ends of the sidewall parts 318. The rails 623 and the grooves 321 have cross-sectional shapes that substantially match each other. According to such a configuration, the pair of rails 623 engages with the pair of grooves 321 so as to be slidable relative to each other in the front-rear direction.

As shown in FIG. 3 through FIG. 5, the locking member 625 of the second engaging part 62 positions the attachment main body 61 relative to the tool main body 31 and is configured to hold the attachment main body 61 at that location. The locking member 625 has a projection 626, which protrudes upward, and the locking member 625 is supported in the interior of the attachment main body 61 so that the projection 626 can move substantially in the up-down direction.

In greater detail, the locking member 625 is a pivot-type lever, in which a rear-end portion serves as a fulcrum, and is biased by a biasing spring (not shown) in a direction in which the projection 626, which is provided on a front-end portion thereof, is oriented upward. In addition, an opening 616 is provided in the second opposing wall 615 of the attachment main body 61. The locking member 625 is normally held at a protruding position at which an upper-end portion of the projection 626 passes through the opening 616 and protrudes more upward than an upper surface of the second opposing wall 615. The locking member 625 is capable of moving from the protruding position to a position at which the upper end of the projection 626 is at the same position as the second opposing wall 615 or is at a position more downward than the second opposing wall 615 (also referred to as a retracted position) in response to the application of a force against the biasing force of the biasing spring.

On the other side, the recessed portion 323 of the first engaging part 32 is provided on the lower-wall part 315 of the second portion 312 of the tool main body 31. The recessed portion 323 has a shape that is configured to mate with the projection 626 of the locking member 625. The attachment main body 61 is held in the state in which the attachment main body 61 is positioned relative to the tool main body 31 by the locking member 625 mating with the recessed portion 323 in the state in which the rails 623 are engaged with the grooves 321. The location of the attachment main body 61 relative to the tool main body 31 at this point in time is referred to as the mounted position.

When mounting the vacuum-adhesion attachment 5 on the tool main body 31, the vacuum-adhesion attachment 5 is moved rearward relative to the tool main body 31 in the state in which the rails 623 are engaged with the grooves 321. During this moving process, when the locking member 625 is pressed down by a lower surface of the lower-wall part 315 of the tool main body 31 and the attachment main body 61 is disposed at the mounted position, the locking member 625 is biased by the biasing spring, and therefore returns to the protruding position to mate with the recessed portion 323.

In addition, as shown in FIG. 3, an unlock button 627, which is configured to be manually manipulated by the user from the exterior of the attachment main body 61, is provided on the attachment main body 61. The unlock button 627 is a manipulatable member configured to operably engage with the locking member 625 in response to manual manipulation, thereby causing the locking member 625 to move from the protruding position to the retracted position.

To make manual manipulation easy for the user in the state in which the vacuum-adhesion attachment 5 is mounted on the hammer drill 2, the unlock button 627 of the present embodiment is disposed on a left-side surface of the attachment main body 61. In addition, the unlock button 627 is a push button type and moves the locking member 625 from the protruding position to the retracted position in response to being pressed. However, the location of the unlock button 627 may be modified from the location given in this example. In addition, the operation system of the unlock button 627 may be another type of system, such as a pivot type, a slide type, or the like.

Moreover, the attachment main body 61 is mounted on the tool main body 31 of the hammer drill 2 and is configured to be electrically connected to the hammer drill 2 when disposed at the mounted position. Specifically, as shown in FIG. 5, the tool main body 31 and the attachment main body 61 are electrically connected to each other via a first terminal part 33 of the tool main body 31 and a second terminal part 63 of the attachment main body 61.

In greater detail, as shown in FIG. 3 through FIG. 5, in the present embodiment, the second terminal part 63 of the attachment main body 61 is configured as a male connector that protrudes rearward from the first opposing wall 614 of the attachment main body 61. The second terminal part 63 has a plurality of terminals 631 (in detail, power-supply terminals and communication terminal(s)). The second terminal part 63 is connected by electrical lines (not shown) to a vacuum pump 71 (a pump motor 72), a controller 70, etc., which are described below.

On the other side, in the present embodiment, the first terminal part 33 of the tool main body 31 is configured as a female connector and is disposed on the rear side of an opening 314, which is formed in the front-wall part 313 of the second portion 312. The first terminal part 33 has a plurality of terminals 331 (in detail, power-supply terminals and communication terminal(s)). The first terminal part 33 is connected to the terminal part 359 (see FIG. 2) of the battery-mount part 358 by an electrical line (not shown).

When the attachment main body 61 is disposed at the mounted position, the second terminal part 63 (male connector) of the attachment main body 61 is inserted through the opening 314, physically coupling with the first terminal part 33 (the female connector) of the tool main body 31 and electrically connecting to the respective power-supply terminals and the communication terminal. With the connection of the power-supply terminals, electric power from the battery 93, which is mounted on the hammer drill 2, can be supplied to each part (e.g., the vacuum pump 71, the controller 70, and a pressure measuring and reporting unit 78 described below) of the vacuum-adhesion attachment 5. In addition, with the connection of the communication terminals, it becomes possible to transmit and receive signals between the controller 40 of the hammer drill 2 and the controller 70 of the vacuum-adhesion attachment 5.

It is noted that, types of attachments different from that of the vacuum-adhesion attachment 5 (e.g., a dust-extracting attachment) are prepared for the hammer drill 2. All these attachments comprise the same second engaging part 62 and second terminal part 63 as with the vacuum-adhesion attachment 5 described above. Accordingly, the user can selectively mount the vacuum-adhesion attachment 5 or the dust-extracting attachment on the hammer drill 2 and use them as needed.

As shown in FIG. 4, the upper-half portion of the attachment main body 61 is configured to support the sliding part 65 (in detail, a first sliding member 651), which is described below. Consequently, an opening 610, which receives the first sliding member 651, is formed on a front surface of the upper-half portion of the attachment main body 61. A portion of the first sliding member 651 that includes the rear end thereof is inserted from the opening 610 into the attachment main body 61 and is supported in the interior of the attachment main body 61 so as to be slidable in the front-rear direction relative to the attachment main body 61.

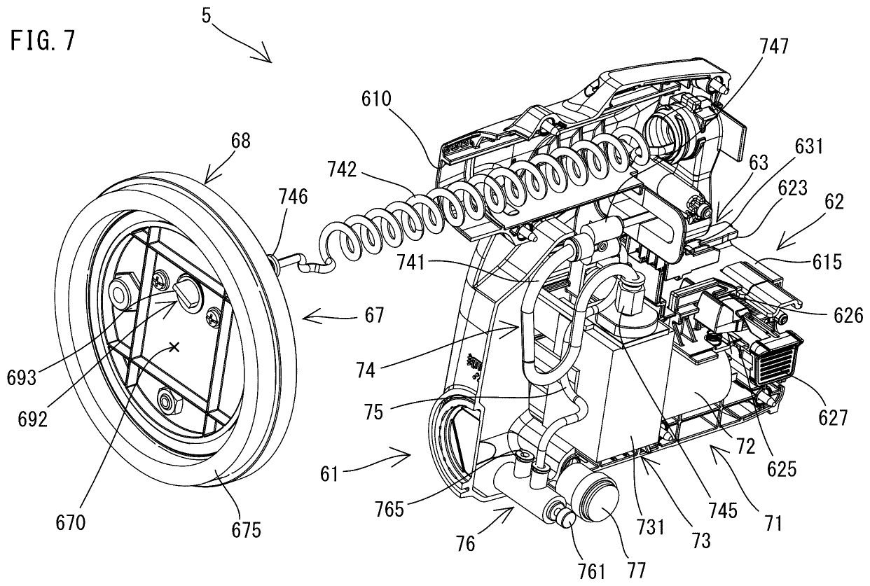

In addition, as shown in FIG. 4 and FIG. 7, the lower-half portion of the attachment main body 61 is configured as a housing part that houses the vacuum pump 71 and the controller 70.

The vacuum pump 71 intakes and exhausts gas (air) inside a container to create a vacuum (reduced pressure) state in the interior of a target container. Any known type of vacuum pump may be utilized as the vacuum pump 71. In the present embodiment, the vacuum pump 71 comprises an electrically-driven-type pump motor 72 and a pump main body 73, which is configured to be driven by the pump motor 72. The pump motor 72 is a DC motor. Although a detailed illustration is omitted, the pump main body 73 comprises: a case 731, which has an air-intake port and an air-exhaust port; and a crank mechanism, which is housed in the case 731 and is operably coupled to the output shaft (not shown) of the pump motor 72. The pump main body 73 is configured to convert the rotational motion of the output shaft of the pump motor 72 into reciprocating motion using the crank mechanism and employ this reciprocating motion to intake and exhaust air.

A suction tube 74 is connected to the pump main body 73 (the air-intake port of the case 731). The suction tube 74 is a flexible pipe. In greater detail, a joint 745, which fluidly connects the suction tube 74 to the pump main body 73, is mounted on the air-intake port of the case 731 of the pump main body 73. A first end of the suction tube 74 is coupled to the joint 745, and a passageway in the interior of the suction tube 74 is in fluid communication with the air-intake port. Although described below in detail, the suction tube 74 extends through the interior of the attachment main body 61 and the interior of the sliding part 65, and a second end (the end on the opposite side of the first end) of the suction tube 74 is coupled to a joint 746 of the suction part 67.

It is noted that, in the present embodiment, the suction tube 74 comprises a first tube 741 and a second tube 742. The first tube 741 and the second tube 742 are connected (i.e., both physically and fluidly connected) in the interior of the attachment main body 61 via a branch joint 747. The first tube 741 extends from a joint 745 of the pump main body 73 to the branch joint 747. The second tube 742 extends from the branch joint 747 to the joint 746 of the suction part 67.

Furthermore, a first end of a release tube 75 is coupled to the branch joint 747. The release tube 75 is a flexible pipe. The passageway in the interior of the release tube 75 is in fluid communication with a passageway in the interior of the suction tube 74 via the branch joint 747. A second end (the end on the opposite side of the first end) of the release tube 75 is coupled to a release valve 76, and the passageway in the interior of the release tube 75 is in fluid communication with an interior space of the release valve 76.

The release valve 76 is in a normally closed state in order to inhibit (block) a flow of outside air into the release tube 75 and, in turn, into a chamber 670 of the suction part 67, which is described below. In response to manual manipulation (e.g., pressing) by the user, the release valve 76 switches from a closed state to an open state, which permits a flow of outside air into the release tube 75. In greater detail, the release valve 76 comprises a release button 761, which is configured to be manipulated manually by the user from the exterior of the attachment main body 61. The release button 761 is a manipulatable member that is normally held at a position that closes off an air-intake port 765 of the release valve 76 and is configured to open the air-intake port 765 in response to manual manipulation by the user. As is described in detail below, the release button 761 is manipulated for the purpose of releasing the vacuum state of the chamber 670 in the suction part 67; i.e., to bring the chamber 670 back to atmospheric pressure, so that the suction part 67 can be easily separated from the work material.

It is noted that, in the present embodiment, to make manual manipulation easy for the user in the state in which the vacuum-adhesion attachment 5 is mounted on the hammer drill 2, the release button 761 is disposed on a left-side surface of the attachment main body 61. In addition, the release button 761 of the present embodiment is a push button type. However, the location of the release button 761 may be modified from the location in this example. In addition, the operation system of the release button 761 may be another type of system such as a pivot type, a slide type, or the like.

The controller 70 is a control apparatus that controls the operation of the vacuum-adhesion attachment 5. In the present embodiment, the controller 70 is constituted by one or more microprocessors that include(s) one or more CPUs (central processing units), ROM, RAM, etc. It is noted that the controller 70 may be configured as another type of processor/processing circuit and memory, similar to the controller 40 of the hammer drill 2.

The controller 70 is electrically connected to a pump switch 77. The pump switch 77 is configured to be manipulated manually (e.g., pressed) by the user from the exterior of the attachment main body 61. Although described in detail below, the controller 70 controls the operation of the vacuum-adhesion attachment 5 (e.g., driving of the pump motor 72 of the vacuum pump 71) based on a signal that is output from the pump switch 77 and a signal that is output from a pressure sensor 781.

It is noted that, in the present embodiment, a push-button-type switch, which can be switched between ON and OFF each time it is pushed, is utilized as the pump switch 77. In addition, to make manual manipulation easy for the user in the state in which the vacuum-adhesion attachment 5 is mounted on the hammer drill 2, the pump switch 77 is disposed, adjacent to the release button 761 of the release valve 76, on a left-side surface of the attachment main body 61. However, similar to the release button 761, the location and/or the system of the pump switch 77 can be modified as appropriate.

The sliding part 65 is explained below.

As shown in FIG. 3 and FIG. 4, the sliding part 65 is an elongated portion to which the attachment main body 61 and the suction part 67 are coupled. The sliding part 65 is supported on the attachment main body 61 so as to be slidable in the front-rear direction relative to the attachment main body 61. The sliding part 65 of the present embodiment comprises the first sliding member 651, which is supported on the attachment main body 61, and a second sliding member 656, which is coupled to the first sliding member 651 and the suction part 67.

The first sliding member 651 is a hollow elongate member. The first sliding member 651 is inserted from the opening 610 of the attachment main body 61 into the upper-half portion of the attachment main body 61 and is supported so as to be slidable in the front-rear direction relative to the attachment main body 61. The slide-engaging structure of the attachment main body 61 and the first sliding member 651 is not particularly limited. Although a detailed illustration is omitted, at least one elongate linear rail may be provided on one of the attachment main body 61 and the first sliding member 651, and at least one elongate-shaped groove, which receives and/or engages the at least one elongate linear rail, may be provided on the other of the attachment main body 61 and the first sliding member 651.

The attachment main body 61 and the first sliding member 651 are configured so that the location of the first sliding member 651 relative to the attachment main body 61 (i.e., the distance in the front-rear direction from the opening 610 to the front end of the first sliding member 651) can be adjusted. In greater detail, a toothed part 661 is provided on an outer surface of a left-side portion of the first sliding member 651. The toothed part 661 comprises a plurality of teeth (projections), and these teeth are disposed equispaced in one row extending in the front-rear direction.

Furthermore, a lock lever 663 is supported on a left-wall portion of the attachment main body 61. The lock lever 663 is a manipulatable member that is manually manipulatable by the user from the exterior of the attachment main body 61. The lock lever 663 of the present embodiment is a slide-type lever. Although a detailed illustration is omitted, an engaging part, which is engageable with the toothed part 661 at an arbitrary location in the front-rear direction along the toothed part 661, is provided in the interior of the lock lever 663. The lock lever 663 is biased downward by a biasing spring, and the engaging part thereof is normally at a position at which it engages with the toothed part 661 (referred to below as an engaged position). Thereby, the first sliding member 651 is positioned relative to the attachment main body 61 and is held at that position.

On the other hand, when the user presses the lock lever 663 upward from the engaged position to a position at which the engaging part is non-engageable with the toothed part 661 (referred to below as the released position), the first sliding member 651 becomes slidable in the front-rear direction relative to the attachment main body 61. The user disposes the first sliding member 651 at a desired location relative to the attachment main body 61 to move the lock lever 663 from the released position to the engaged position, and thereby the user can change the location of the front end of the first sliding member 651 relative to the opening 610. Thereby, the location of the suction part 67 in the front-rear direction relative to the attachment main body 61 can also be changed.

A variety of tool accessories 91 having different lengths can be mounted in the tool holder 45 of the hammer drill 2 in accordance with the actual work to be performed. Thereby, by adjusting the location of the first sliding member 651 relative to the attachment main body 61, the user can dispose (place) the suction part 67 at an appropriate location at the start of work in accordance with the length of the tool accessory 91 actually mounted on the hammer drill.

The second sliding member 656 is a hollow elongate member. The second sliding member 656 is partially inserted into the first sliding member 651 and is supported by the first sliding member 651 so as to be slidable in the front-rear direction relative to the first sliding member 651 (and to the attachment main body 61). Although a detailed illustration is omitted, the slide-engaging structure of the first sliding member 651 and the second sliding member 656 may be similar to the slide-engaging structure of the attachment main body 61 and the first sliding member 651.

It is noted that the sliding part 65 may be configured as only one sliding member. Specifically, the first sliding member 651 may be omitted, and the second sliding member 656 may be supported directly on the attachment main body 61 so as to be slidable in the front-rear direction relative to the attachment main body 61.

The suction part 67 is explained below.

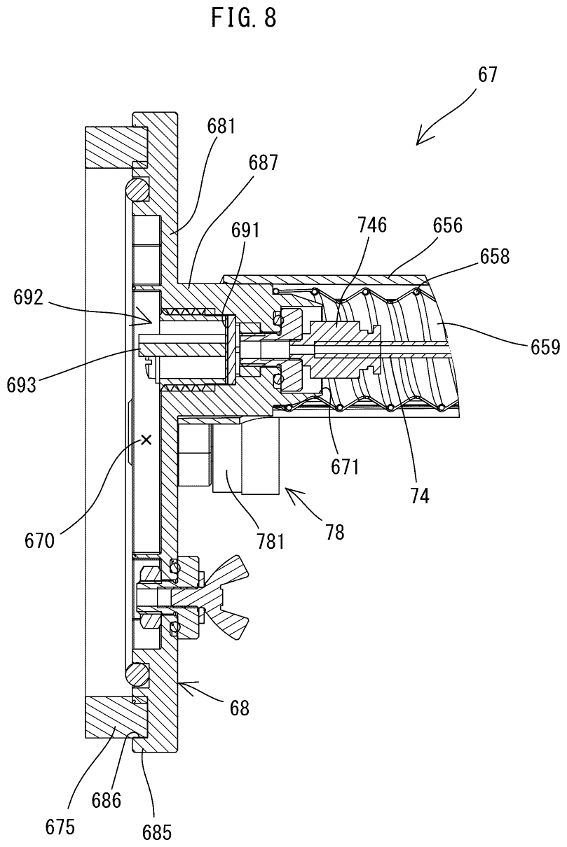

The suction part 67 is the portion that is fixed to a work material (workpiece) by vacuum adhesion. As shown in FIG. 3, FIG. 7, and FIG. 8, the suction part 67 of the present embodiment comprises a short tube-shaped base part 68, which has a closed rear end and an open front end, and a loop-shaped (endless) sealing member 675, which is mounted on the base part 68.

In greater detail, the base part 68 comprises a plate-shaped base wall part 681, which is disposed to intersect with the front-rear direction, and a tube-shaped circumferential-wall part 685, which is provided along the outer edge of the base wall part 681 and protrudes forward from the base wall part 681. It is noted that, although the base wall part 681 of the present embodiment is substantially a circular shape, the base wall part 681 may be any other shape. Alternatively, the base part 68 may be formed in a cup shape in which there is no clear boundary between the base wall part 681 and the circumferential-wall part 685. The base part 68 is formed as a rigid body having sufficient strength to inhibit (prevent) movement of the attachment main body 61 and the sliding part 65 relative to the suction part 67. The base part 68 of the present embodiment is made of metal. In greater detail, to make it more lightweight, the base part 68 may be formed from aluminum, magnesium, or any of their alloys, which have a relatively low specific gravity (density) while also having high stiffness and durability.

The sealing member 675 is mounted on the base part 68 so as to protrude forward of the front end of the circumferential-wall part 685. In greater detail, as shown in FIG. 8, a ring-shaped (endless) groove 686 that spans (extends along) the entire circumference of the circumferential-wall part 685 is formed on the front end of the circumferential-wall part 685 of the base part 68. The sealing member 675 has a circular-tube shape, one end portion in the axial direction thereof is fitted into and in tight contact with the groove 686, and the remaining portion thereof is held in the state in which the remaining portion protrudes forward from the groove 686. The sealing member 675 is formed from an elastic body (e.g., an elastomer or a synthetic-resin foam). When the suction part 67 suctions the work material, the sealing member 675 elastically deforms so as to flatten and thereby adhere to the work material, thus separating the space (the cavity or chamber 670) formed in the interior of the base part 68 and the sealing member 675 from the space on the outer side of the base part 68 and the sealing member 675. Thereby, the space surrounded (enclosed) by the work material and the suction part 67 functions as a chamber (vacuum chamber) 670 that has high airtightness. The chamber 670 is brought to a vacuum (reduced pressure) state by driving of the vacuum pump 71.

A tube-shaped coupling part 687 is provided on the base wall part 681 of the base part 68. The coupling part 687 protrudes from the base wall part 681 in the opposite direction of the circumferential-wall part 685. The interior space of the coupling part 687 is in fluid communication with the chamber 670. An opening at the tip (rear end) of the coupling part 687 is a suction port 671 for suctioning air from the chamber 670.

The second sliding member 656 of the sliding part 65 is coupled to the coupling part 687. In greater detail, a front-end portion of the second sliding member 656 is fitted on the outer circumference of the coupling part 687 and thereby fixed. Thereby, the suction part 67 can move integrally with the second sliding member 656 relative to the attachment main body 61.

As shown in FIG. 4 and FIG. 8, a biasing member 658 is disposed in the interior of the sliding part 65. The biasing member 658 is configured to bias the second sliding member 656 and the suction part 67 on the one hand and the attachment main body 61 on the other hand in a direction so as to move away from each other in the front-rear direction. That is, the biasing member 658 is configured to bias the second sliding member 656 and the suction part 67 forward relative to the attachment main body 61. The biasing member 658 of the present embodiment is a compression coil spring. The rear end of the biasing member 658 is supported in the interior of the attachment main body 61, and the front end of the biasing member 658 abuts on the coupling part 687. According to this type of configuration, the second sliding member 656 and the suction part 67 are normally held at the forward-most position within the range of movement. It is noted that, in the present embodiment, a tube-shaped sheet 659, which is flexible, is integrated with the biasing member 658.

In addition, the joint 746 is mounted in the suction port 671 of the coupling part 687. As described above, the second end of the suction tube 74 is coupled to the joint 746. Thereby, the passageway inside the suction tube 74 communicates with the chamber 670 via the joint 746. The passageway from the chamber 670 to the vacuum pump 71 constitutes a suction path through which air suctioned by the vacuum pump 71 is transferred.

It is noted that the portion of the suction tube 74 (in particular, the second tube 742) that extends through the interior of the sliding part 65 is disposed inside the tube-shaped sheet 659. Thereby, the sliding part 65 and the suction tube 74 are prevented from contacting each other when the sliding part 65 slides relative to the attachment main body 61. Thereby, the possibility of damage to the suction tube 74 can be reduced.

As shown in FIG. 8, a filter 691 is disposed in the interior of the coupling part 687 (i.e., a portion of the suction path that is upstream of the suction tube 74 in the airflow direction during suctioning by the vacuum pump 71). The type of the filter 691 is not particularly limited and, for example, a HEPA (high-efficiency particulate air) filter, a powder filter, a nonwoven filter, or a synthetic-resin foam can be utilized. During processing work (particularly during drilling work) by the hammer drill 2, a relatively large amount of dust is produced. The filter 691 can curtail the amount of dust entering from the chamber 670 side into the suction tube 74 and thereby can protect the vacuum pump 71. In addition, the filter 691 can curtail clogging of the suction tube 74 with dust.

The filter 691 is held in the interior of the coupling part 687 by a filter stopper 692 so that the filter 691 does not come out toward the chamber 670. The filter stopper 692 has a circular-tube shape and is configured so that air can flow through the interior of the filter stopper 692. A screw thread is formed on the outer-circumferential surface of the filter stopper 692. The filter stopper 692 has a knob part 693. The filter stopper 692 is inserted from the chamber 670 side (front side) into the coupling part 687, engages with the screw thread formed on an inner surface of the coupling part 687, and thereby is fixed to the coupling part 687 in a detachable manner. A portion of the knob part 693 protrudes into the interior of the chamber 670. The user can easily detach the filter stopper 692 from the coupling part 687 by gripping the knob part 693 and rotating the filter stopper 692. Thereby, cleaning and/or replacement of the filter 691 becomes easy.

In addition, as shown in FIG. 3, a pressure measuring and reporting unit 78 is mounted on the suction part 67. The pressure measuring and reporting unit 78 comprises the pressure sensor 781 and a reporting (notifying, indicator) part 783. The pressure measuring and reporting unit 78 (the pressure sensor 781 and the reporting part 783) is electrically connected to the controller 70 via an electrical line (not shown). It is noted that the electrical line that connects the pressure measuring and reporting unit 78 and the controller 70 is preferably disposed in the interior of the tube-shaped sheet 659 of the biasing member 658, similar to the suction tube 74. Electric power may be supplied to the pressure measuring and reporting unit 78 directly from the second terminal part 63 or via the controller 70.

The pressure sensor 781 is configured to measure the pressure (reduced pressure) in the chamber 670. The type of the pressure sensor 781 is not particularly limited, and the measurement of pressure may be performed by any known pressure measurement system. The pressure sensor 781 is configured to output, to the controller 70 at a prescribed cycle, a signal indicating the measured pressure. Although described in detail below, in the present embodiment, the controller 70 controls the operation of the vacuum-adhesion attachment 5 based on the signal from the pressure sensor 781.

The reporting part 783 is configured to report (notify, indicate) information pertaining to the state of the power-tool system 1. Although a detailed illustration is omitted, in the present embodiment, the reporting part 783 includes an LED capable of reporting information using light. The LED turns ON, flashes, or turns OFF based on a signal from the controller 70. It is noted that a single LED is given as an example in the explanation below; however, a plurality of LEDs may be provided having the same or different colors. In addition, in addition to or instead of the LED(s), the reporting part 783 may also include a buzzer capable of reporting information via sound. In this situation, the user can perceive the state of the power-tool system 1 without focusing on the reporting part 783.

The operation of the power-tool system 1 is explained below. It is noted that, as a concrete example of operation, an example of operation is described for when a tool accessory 91 for drilling (e.g., a drill bit) is mounted on the hammer drill 2 and drilling work is to be performed.

After mounting a suitable tool accessory 91 on the tool holder 45, as described above, the user mounts the attachment main body 61 of the vacuum-adhesion attachment 5 on the tool main body 31 of the hammer drill 2 and adjusts the position of the first sliding member 651 relative to the attachment main body 61. Thereafter, the user abuts the sealing member 675 of the suction part 67 of the vacuum-adhesion attachment 5 on the work material and presses the pump switch 77 to turn the pump ON. Upon acquiring an ON signal from the pump switch 77, the controller 70 energizes the pump motor 72 of the vacuum pump 71 and thereby starts driving of the vacuum pump 71. Thereby, air is suctioned out of the chamber 670 of the suction part 67 via the suction port 671, passes through the suction tube 74, enters the vacuum pump 71, and is exhausted from the air-exhaust port. It is noted that, although omitted from the illustration, an air-exhaust port, which exhausts to the exterior, air exhausted from the vacuum pump 71 is provided in the attachment main body 61.

Because the pressure in the chamber 670 drops below atmospheric pressure on the exterior of the chamber 670 (the chamber is brought to a vacuum (reduced pressure) state) by driving of the vacuum pump 71, the suction part 67 adheres to the work material and thereby is brought to a state in which it is fixed to the work material. The sealing member 675 is pressed and elastically deformed against the surface of the work material to adhere to the work material and thereby maintain the chamber 670 in an airtight state.

Upon acquiring a signal indicating that the pump switch 77 has been turned OFF during drive of the vacuum pump 71, the controller 70 stops driving of the vacuum pump 71.

In contrast, while an OFF signal indicating that the pump switch 77 has been turned OFF has not been acquired during drive of the vacuum pump 71, the controller 70 monitors the signal from the pressure sensor 781 and determines whether the measured pressure in the chamber 670 has become lower than a prescribed first threshold. The first threshold is set as a pressure value that is sufficient for obtaining (generating) the required (sufficient) suction force to securely fix (adhere) the power-tool system 1 to the work material.

When the controller 70 determines that the measured pressure is lower than the first threshold (i.e., the controller 70 determines that a suitable vacuum pressure has been obtained/generated), the controller 70 stops energizing the pump motor 72 to stop driving of the vacuum pump 71. In this state, except for slight leakage, the air in the interior of the chamber 670, the suction tube 74, the release tube 75, and the vacuum pump 71 is not actively exhausted to the exterior. Thereby, the pressure inside the chamber 670 does not rapidly increase and the fixed state of the power-tool system 1 is maintained for a certain period of time.

Upon acquiring a signal indicating that the pump switch 77 was turned OFF during stoppage of driving of the vacuum pump 71, the controller 70 stops monitoring the signals from the pressure sensor 781 and does not drive the vacuum pump 71 until the pump switch 77 is turned ON again.

In contrast, after the vacuum pump 71 stops and while the pump switch 77 is not turned OFF, the controller 70 monitors the signal from the pressure sensor 781. Upon determining that air leakage has exceeded a certain amount, and the measured pressure is greater than a prescribed second threshold (i.e., the degree of vacuum has decreased), the controller 70 resumes energizing the pump motor 72 to resume driving of the vacuum pump 71. The second threshold is a value that is greater than the first threshold. However, similar to the first threshold, the second threshold is set to a value that is sufficient to obtain the required suction force to securely fix the power-tool system 1 to the work material.

In this manner, in the present embodiment, while the pressure in the chamber 670 is within a range between the first threshold and the second threshold (inclusive of the first threshold and the second threshold), i.e., while the suction force required for the power-tool system 1 to fix the work material has been generated, the energizing of the pump motor 72 is suspended. Wasteful electric-power consumption can be curtailed by this kind of control of the driving of the vacuum pump 71. Particularly in the present embodiment, because the vacuum pump 71 is driven by the electric power supplied from the rechargeable battery 93 that is mounted on the hammer drill 2, there is the advantage that the usage time (run time) of the battery 93 can be made longer by energizing the vacuum pump 71 only as needed to maintain a secure adhesion of the suction part 67 to the work material.

In addition, the controller 70 controls driving of the LED(s) of the reporting part 783 together with controlling driving of the vacuum pump 71. Specifically, in response to the measured pressure becoming lower than the first threshold, the controller 70 reports, by turning ON the LED(s) of the reporting part 783, that the power-tool system 1 is in a fixed state. In addition, if the state in which the measured pressure is greater than the second threshold has continued for a prescribed count or longer after driving of the vacuum pump 71 has been suspended as described above, then the controller 70 reports, by flashing the LED(s) of the reporting part 783, that the fixing of the power-tool system 1 has weakened. It is noted that the state in which the measured pressure is greater than the second threshold has continued for the prescribed count or longer is another way of saying that the state in which the measured pressure is greater than the second threshold has continued for the prescribed time.

In this manner, by using the reporting part 783 to report information (e.g., the pressure within the chamber 670), the user can easily perceive the state (e.g., the adherence strength) of the power-tool system 1. Thereby, it becomes possible for the user to take appropriate measures in accordance with the state of the power-tool system 1. When the LED(s) is (are) in the turned-ON state, for example, the user can easily perceive that the power-tool system 1 is in the fixed state even though the vacuum pump 71 is not being driven. Thereby, the user can loosen their grip on the grip part 351 and the auxiliary handle 95 to reduce fatigue. In addition, when the LED(s) is (are) in the flashing state, the user can easily perceive that the fixing (adherence) of the power-tool system 1 to the work material has weakened. Thereby, the user can take measures, such as more firmly gripping the grip part 351 and the auxiliary handle 95 or releasing the pressure on the trigger 352 to stop driving of the motor 41 of the hammer drill 2. It is noted that, as described above, in an embodiment in which the reporting part 783 includes a buzzer that reports via sound, the user can perceive, without visually observing the reporting part 783 (the LED(s)), the state of the power-tool system 1 by whether the buzzer has sounded and/or by a change in the buzzer sound.

It is noted that, in the present embodiment, the reporting part 783 reports information using the emission of light from the LED(s). The reporting part 783 is disposed on the rear side of the suction part 67. Thereby, the user can easily see the LED(s) even during the drilling work.

It is noted that, as the drilling work by the hammer drill 2 progresses, the hammer drill 2 moves along drive axis DX in a direction approaching the work material (i.e., the hammer drill 2 moves forward). In contrast, although the suction part 67 of the vacuum-adhesion attachment 5 remains in the state in which it is pressed against the surface of the work material and does not move relative to the work material, the second sliding member 656 is pressed into the interior of the first sliding member 651 against the biasing force of the biasing member 658. Thereby, the attachment main body 61 and the first sliding member 651, which are mounted on the tool main body 31 of the hammer drill 2, can move integrally with the hammer drill 2 in the direction that approaches the work material. Thereby, in the state in which the user holds only the hammer drill 2, the user can advance the drilling work smoothly while moving the hammer drill 2 in accordance with the progress of the drilling work.

When the user ends the drilling work, turns the pump switch 77 OFF, and presses the release button 761, outside air at atmospheric pressure flows into the release valve 76 from the air-intake port 765. The outside air then passes through the release tube 75 and the suction tube 74 and flows into the chamber 670. At this time, any dust that has adhered to the filter 691 can be blown away (out) by the flow of air passing through the filter 691, which is disposed in the interior of the coupling part 687, from the suction tube 74 side toward the chamber 670 side. Thereby, because clogging of the filter 691 can be mitigated, it is possible to avoid a decrease in the suction force during repeated operations while also reducing the frequency of cleaning and/or replacement of the filter 691.

When the pressure in the chamber 670 increases and becomes substantially equal to atmospheric pressure, the user can easily separate the suction part 67 and, in turn, the power-tool system 1, from the work material.

As explained above, the power-tool system 1 of the present embodiment includes the hammer drill 2 and the vacuum-adhesion attachment 5, which is an apparatus that is separate from the hammer drill 2 and is integratable with the hammer drill 2 by being mounted on the tool main body 31 in a detachable manner. Thereby, when the suction part 67 is fixed to the work material by vacuum adhesion in the state in which the vacuum-adhesion attachment 5 is mounted on the tool main body 31, the entire power-tool system 1 is fixed to the work material.

Ordinarily, when performing drilling work using only the hammer drill 2 (i.e. without the vacuum-adhesion attachment 5), the user must hold the hammer drill 2 firmly and press the tool accessory 91 against the work material, which may be tiring. In contrast, when the vacuum-adhesion attachment 5 is mounted on the hammer drill 2 and the entire power-tool system 1 is fixed to the work material during the drilling work, only a small holding force is needed by the user to hold the hammer drill 2, thereby reducing user fatigue. In addition, because shaking (vibration) of the tool accessory 91 is curtailed, a hole can be formed (drilled) with good accuracy. Moreover, because the user can mount the vacuum-adhesion attachment 5 on the hammer drill 2 only in situations as needed, and use it as the power-tool system 1, convenience for the user is improved.

In addition, in the present embodiment, the pump switch 77, which is manipulated manually (e.g., pressed) to start and stop the vacuum pump 71, is provided on the vacuum-adhesion attachment 5. Thereby, the user can cause the power-tool system 1 to be fixed to the work material at a desired timing by manually manipulating the pump switch 77.

### Second Embodiment

A second embodiment of the present disclosure will be explained below. It is noted that the physical configuration of the power-tool system according to the second embodiment is substantially the same as the power-tool system 1 of the first embodiment. On the other hand, a portion of the control of the operation of the power-tool system 1 is different from that of the first embodiment. Therefore, explanations referring to the same reference numbers regarding the configuration of the power-tool system 1 are omitted or abbreviated, and only those points in the control of the operation of the power-tool system 1 that differ are explained below in detail.

In the present embodiment, driving of the vacuum pump 71 (energization of the pump motor 72) is started in response to the trigger switch 353 of the hammer drill 2 being turned ON, even if the pump switch 77 is not turned ON.

In greater detail, as described above, when the second terminal part 63 of the vacuum-adhesion attachment 5 and the first terminal part 33 of the hammer drill 2 are coupled (connected, placed in contact), the respective communication terminals are electrically connected. When the controller 40 of the hammer drill 2 acquires an ON signal from the trigger switch 353, the controller 40 outputs a signal, which indicates that the trigger switch 353 is turned ON, to the controller 70 of the vacuum-adhesion attachment 5 via the first terminal part 33 and the second terminal part 63. Upon acquiring this signal, the controller 70 immediately starts to energize the pump motor 72 to thereby start driving of the vacuum pump 71. On the other hand, the controller 40 of the hammer drill 2 starts driving of the motor 41 of the hammer drill 2 after a prescribed time has elapsed after outputting the signal to the controller 70. The prescribed time can be set, for example, in accordance with the time needed from the point in time at which driving of the vacuum pump 71 started until the suction part 67 is adhered and securely fixed to the work material.

In addition, in the present embodiment, driving of the vacuum pump 71 may be stopped in response to the trigger switch 353 of the hammer drill 2 being turned OFF. In greater detail, upon acquiring an OFF signal from the trigger switch 353, the controller 40 of the hammer drill 2 outputs a prescribed signal to the controller 70 of the vacuum-adhesion attachment 5. The controller 40 of the hammer drill 2 stops the motor 41 of the hammer drill 2 immediately after outputting the signal to the controller 70.

On the other hand, upon acquiring the signal from the controller 40, the controller 70 of the vacuum-adhesion attachment 5 stops energizing the pump motor 72 after a prescribed time has elapsed, thereby stopping driving of the vacuum pump 71. The prescribed time may be the same as the prescribed time described above. This is to account for the possibility in which suction is not being sufficiently performed during the interval from when the trigger switch 353 is turned ON until the trigger switch 353 is turned OFF, and thus the suction part 67 is not fixed to the work material. However, driving of the pump motor 72 may be stopped at substantially the same timing as that of the motor 41 of the hammer drill 2.

It is noted that drive control of the vacuum pump 71 may be performed in accordance with the pump switch 77 being turned ON and OFF, regardless of the trigger switch 353 being turned ON and OFF, similar to the first embodiment. The pump switch 77 may be omitted from the vacuum-adhesion attachment 5 in an embodiment in which drive control of the vacuum pump 71 is performed only in accordance with the trigger switch 353 being turned ON and OFF.

In addition, in the present embodiment as well, the pressure of the chamber 670, which is measured by the pressure sensor 781, may be employed in the control of the vacuum pump 71 and/or the reporting part 783, similar to the first embodiment. Energizing of the pump motor 72 may be suspended while the trigger switch 353 is in the ON state, for example, in the situation in which the pressure of the chamber 670 is in the range between the first threshold and the second threshold (inclusive of the first threshold and the second threshold). In addition, the reporting part 783 may report the state in which the fixing of the power-tool system 1 has weakened.

Moreover, in the present embodiment, the controller 70 of the vacuum-adhesion attachment 5 can output the signal acquired from the pressure sensor 781 to the controller 40 of the hammer drill 2. The controller 40 of the hammer drill 2 may control driving of the motor 41 of the hammer drill 2 based on the acquired signal.

After outputting a signal, which indicates that the trigger switch 353 is turned ON, to the controller 70 of the vacuum-adhesion attachment 5, for example, the controller 40 may monitor the signals (the pressure of the chamber 670) acquired from the pressure sensor 781. The controller 40 may start driving of the motor 41 after the pressure in the chamber 670 falls below the first threshold (i.e., after a sufficient degree of vacuum (reduced pressure) has been obtained). The period required from the point in time that driving of the vacuum pump 71 starts until the suction part 67 is securely fixed to the work material can change depending on the air permeability, etc., of the work material. Therefore, it becomes possible to start driving of the motor 41 in the state in which the suction part 67 is more securely fixed in the situation in which driving of the motor 41 is started after the pressure in the chamber 670 falls below the first threshold than in the situation in which driving of the motor is started after a prescribed time has elapsed. For the same reason, after acquiring a signal from the controller 40 of the hammer drill 2 indicating that the trigger switch 353 has been turned OFF, the controller 70 of the vacuum-adhesion attachment 5 may use the pressure of the chamber 670 falling below the first threshold as a condition for stopping driving of the vacuum pump 71.

In addition, the controller 40 may stop driving of the motor 41 of the hammer drill 2 if, for example, it is determined that the state in which the measured pressure is greater than the second threshold has continued for the prescribed count or more. As a result, this can prevent a situation in which drilling work continues in the state in which the power-tool system 1 is not securely fixed to the work material, and thereby the accuracy of the hole to be formed (drilled) will decrease. In addition, the reporting part 783 may report this information in the situation in which driving of the motor 41 of the hammer drill 2 has stopped.

It is noted that the reporting part 783 is disposed on the hammer drill 2 (e.g., on the tool main body 31) and not on the vacuum-adhesion attachment 5 and may be electrically connected to the controller 40 of the hammer drill 2. In this situation, the controller 40 may control driving of the LED(s) of the reporting part 783. The controller 40 may, for example, report the information pertaining to the fixed state described above based on the signal acquired from the pressure sensor 781 or may report prescribed information when the remaining charge of the battery 93 falls below a prescribed threshold.

As explained above, in the present embodiment, driving of the vacuum pump 71 is started in response to the trigger switch 353 of the hammer drill 2 being turned ON. Thereby, the user can cause driving of the motor 41 of the hammer drill 2 and driving of the vacuum pump 71 of the vacuum-adhesion attachment 5 to start by merely performing a manual manipulation (the pressing of the trigger 352) that turns ON the trigger switch 353 of the hammer drill 2. In addition, after a prescribed time has elapsed from the start of driving of the vacuum pump 71, that is, after a prescribed time has elapsed since the suction part 67 has started to adhere to the work material (alternatively, after the pressure of the chamber 670 has fallen below the first threshold), driving of the motor 41 of the hammer drill 2 is started. Thereby, it becomes possible for the user to reduce the manual holding force, at an early stage, that is applied to the hammer drill 2 after pressing the trigger 352.

In the example described in the present embodiment, although the controller 40 of the hammer drill 2 controls driving of the motor 41, the controller 70 of the vacuum-adhesion attachment 5 controls driving of the vacuum pump 71. Nevertheless, for example, the controller 40 of the hammer drill 2 may control driving of both the motor 41 and the vacuum pump 71. In such an embodiment, the controller 70 of the vacuum-adhesion attachment 5 may be omitted. In addition, the controller 40 of the hammer drill 2 and the controller 70 of the vacuum-adhesion attachment 5 may transmit and receive signals between each other via wireless communication.

Correspondence relationships between the structural elements (features) of the above-mentioned embodiments and the structural elements (features) of the present disclosure or invention are indicated below. However, the structural elements of the embodiments are merely examples and do not limit the structural elements of the present disclosure or the present invention.

The power-tool system 1 is one example of a “power-tool system.” The hammer drill 2 is one example of a “power tool.” The tool main body 31 is one example of a “tool main body.” The vacuum-adhesion attachment 5 is one example of a “vacuum-adhesion attachment.” The attachment main body 61 is one example of an “attachment main body.” The vacuum pump 71 is one example of a “vacuum pump.” The suction part 67 is one example of a “suction part.” The chamber 670 is one example of a “chamber.” The release valve 76 is one example of a “valve.”

The pump switch 77 is one example of a “pump switch.” The pressure sensor 781 is one example of a “pressure sensor.” The controller 70 of the vacuum-adhesion attachment 5 of the first embodiment is one example of a “control apparatus.” The reporting part 783 (LED(s)) is one example of a “reporting part.” The sliding part 65 is one example of a “sliding part.” The first sliding member 651 and the second sliding member 656 are examples of a “first sliding member” and a “second sliding member,” respectively. The filter 691 is one example of a “filter.”

The motor 41 is one example of a “motor of a power tool.” The trigger switch 353 is one example of a “main switch.” The first terminal part 33 and the second terminal part 63 are examples of a “first terminal part” and a “second terminal part,” respectively. The controller 40 of the hammer drill 2 and the controller 70 of the vacuum-adhesion attachment 5 of the second embodiment are, as a whole or individually, one example of a “control apparatus.”

It is noted that the above-mentioned embodiments are merely illustrative examples, and vacuum-adhesion attachments and power-tool systems according to the present disclosure are not limited to the vacuum-adhesion attachment 5 and the power-tool system 1 illustrated in an exemplary manner. For example, the modifications illustrated in an exemplary manner below can be added. In addition, at least one of these modifications and at least one of the vacuum-adhesion attachment 5 (illustrated in an exemplary manner in the embodiments), the power-tool system 1 (illustrated in an exemplary manner in the embodiments), and the features set forth in the claims may be combined and utilized.

For example, the power tool, on which the vacuum-adhesion attachment according to the present disclosure is mounted, is not limited to the hammer drill 2. The vacuum-adhesion attachment according to the present disclosure is, in particular, preferably mountable on a power tool that requires a relatively large force to hold the power tool during processing work or on the tool main body of a power tool for which it is preferable that the tool accessory is held accurately in the same location during the processing work.

Impact (hammer) tools, which perform only operations in which the tool accessory is driven linearly (e.g., a power hammer (demolition hammer or scraper)), and drill tools (e.g., a core drill), which are different from the hammer drill 2, can be given as non-limiting examples of such power tools according to the present teachings. In many situations, a core drill is mounted on a support body, called a drill stand, that is fixed to the work material by an anchor and is used (operated) in this mounted state. The vacuum-adhesion attachment according to the present disclosure can be used suitably in place of a drill stand. The vacuum-adhesion attachment is different from a drill stand in that there is no need to create a hole for anchoring to the work material, and therefore the vacuum-adhesion attachment excels in convenience.

In addition, the power tool may operate, without a rechargeable battery, using electric power supplied from an external AC power supply via a power-supply cord. The vacuum-adhesion attachment comprises a battery-mount part and may operate using electric power supplied from a rechargeable battery that is mounted on this battery-mount part.

The coupling mechanism between the tool main body of the power tool and the attachment main body of the vacuum-adhesion attachment according to the present disclosure is not limited to the first engaging part 32 and the second engaging part 62 of the above-mentioned embodiments and may be modified as appropriate. The tool main body and the attachment main body may be coupled, for example, by the engagement of at least one protruding portion provided on one of the tool main body and the attachment main body and at least one recessed portion provided in the other of the tool main body and the attachment main body. The tool main body and the attachment main body may be coupled by employing separate devices or fasteners.

In consideration of the gist of the present invention and the above-mentioned embodiments, the following aspects are formulated. At least one of the aspects below may be combined with at least one of the features of the embodiments and the modified examples thereof or at least one of the features set forth in the claims and utilized.

### Aspect 1

The attachment main body comprises a first engaging part, which is provided on the tool main body, and a second engaging part, which is configured to mechanically engage with the first engaging part;
the first engaging part includes at least one recessed portion or at least one protruding portion; and
the second engaging part includes: a protruding portion that is engageable with the at least one recessed portion of the first engaging part, or a recessed portion that is engageable with the at least one protruding portion of the first engaging part.

### Aspect 2

The suction part comprises a base part, which is a rigid body, and an elastically deformable sealing member, which is mounted on the base part;
the chamber is defined by the base part and the sealing member; and
the sealing member is configured to tightly contact the surface of the work material to which it is pressed and to bring the chamber to an airtight state.

### Aspect 3

A manipulatable part of the valve is disposed in a manner such that it is manually manipulatable from the exterior of the attachment main body.

### Aspect 4

The manipulatable part of the valve and the pump switch are disposed adjacent to each other on the attachment main body.

### Aspect 5

The vacuum-adhesion attachment further comprises:
a suction tube, which is connected to the vacuum pump and the suction part; and
a release tube, which is connected to the suction tube and the valve.

The suction tube 74 is one example of the “suction tube” of the present aspect. The release tube 75 is one example of the “release tube” of the present aspect.

### Aspect 6

The vacuum-adhesion attachment comprises:
the suction tube, which is connected to the vacuum pump and the suction part; and
a compression coil spring configured to bias the suction part in a first direction in a direction away from the attachment main body;
wherein:
the compression-coil spring is integrated with a flexible, tube-shaped member; and
the suction tube extends in the interior of the flexible, tube-shaped member inside the sliding part.

The biasing member 658 is one example of the “compression-coil spring” of the present aspect. The tube-shaped sheet 659 is one example of the “flexible, tube-shaped member” of the present aspect.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as one or both of the controllers 40, 70, is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the controllers 40, 70 of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

As was mentioned above, programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine-or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the controllers 40, 70, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performance, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the control unit have been identified as “parts” or “steps”, it is understood that such parts or steps need not be physically separate or distinct electrical components, but rather may be different blocks of program code that are executed by the same hardware component, e.g., one or more microprocessors.

### EXPLANATION OF THE REFERENCE NUMBERS

1 Power-tool system
2 Hammer drill
5 Vacuum-adhesion attachment
31 Tool main body
311 First portion
312 Second portion
313 Front-wall part
314 Opening
315 Lower-wall part
318 Sidewall part
32 First engaging part
321 Groove
323 Recessed portion
33 First terminal part
331 Terminal
35 Handle part
351 Grip part
352 Trigger
353 Trigger switch
355 Upper-side coupling part
357 Lower-side coupling part
358 Battery-mount part
359 Terminal part
40 Controller
41 Motor
43 Drive mechanism
45 Tool holder
61 Attachment main body
610 Opening
614 First opposing wall
615 Second opposing wall
616 Opening
62 Second engaging part
621 Sidewall part
623 Rail
625 Locking member
626 Projection
627 Unlock button
63 Second terminal part
631 Terminal
65 Sliding part
651 First sliding member
656 Second sliding member
658 Biasing member
659 Tube-shaped sheet
661 Toothed part
663 Lock lever
67 Suction part
670 Chamber
671 Suction port
675 Sealing member
68 Base part
681 Base wall part
685 Circumferential-wall part
686 Groove
687 Coupling part
691 Filter
692 Filter stopper
693 Knob part
70 Controller
71 Vacuum pump
72 Pump motor
73 Pump main body
731 Case
74 Suction tube
741 First tube
742 Second tube
745 Joint
746 Joint
747 Branch joint
75 Release tube
76 Release valve
761 Release button
765 Air-intake port
77 Pump switch
78 Pressure measuring and reporting unit
781 Pressure sensor
783 Reporting part
91 Tool accessory
93 Battery
95 Auxiliary handle
DX Drive axis

1. A vacuum-adhesion attachment for a power tool, comprising:
an attachment main body configured to be mounted on a tool main body of the power tool in a detachable manner;
a vacuum pump, which is housed in the attachment main body;
a suction part, which has a chamber in fluid communication with the vacuum pump and is configured to be adhered to a surface of a work material in response to the chamber being brought to a reduced pressure state by driving of the vacuum pump; and
a valve, which is in fluid communication with the chamber of the suction part, is normally in a closed state to block a flow of outside air into the chamber, and is configured to be switched, in response to manual manipulation by a user, to an open state that permits a flow of outside air into the chamber.

2. The vacuum-adhesion attachment according to claim 1, further comprising a pump switch configured to be manually manipulated to start and stop driving of the vacuum pump.

3. The vacuum-adhesion attachment according to claim 1, further comprising a pressure sensor configured to measure the pressure in the chamber of the suction part or the pressure in the interior of a suction path that fluidly connects the chamber and the vacuum pump.

4. The vacuum-adhesion attachment according to claim 3, further comprising:
a control apparatus configured to control operation of the vacuum-adhesion attachment based on the pressure measured by the pressure sensor;
wherein the control apparatus is configured to stop driving of the vacuum pump in response to the measured pressure falling below a first threshold during driving of the pump, and thereafter to resume driving of the vacuum pump in response to the measured pressure exceeding a second threshold that is greater than the first threshold.

5. The vacuum-adhesion attachment according to claim 1, further comprising a reporting part configured to report information indicating a state of the vacuum-adhesion attachment.

6. The vacuum-adhesion attachment according to claim 5, further comprising:
a pressure sensor configured to measure the pressure in the chamber of the suction part or the pressure in the interior of a suction path that fluidly connects the chamber and the vacuum pump; and
a control apparatus configured to control operation of the vacuum-adhesion attachment based on the pressure measured by the pressure sensor;
wherein:
the control apparatus is configured to stop driving of the vacuum pump in response to the measured pressure falling below a first threshold during driving of the pump, and thereafter to resume driving of the vacuum pump in response to the measured pressure exceeding a second threshold that is greater than the first threshold; and
the reporting part is configured to report prescribed information in response to: (i) the measured pressure exceeding the second threshold for a prescribed time period or (ii) the measured pressure exceeding the second threshold for a prescribed count within a prescribed time period.

7. The vacuum-adhesion attachment according to claim 1, further comprising a sliding part, which is coupled to the suction part and is supported on the attachment main body so as to be slidable in a first direction relative to the attachment main body.

8. The vacuum-adhesion attachment according to claim 7, wherein:
the sliding part comprises:
a first sliding member, which is supported on the attachment main body; and
a second sliding member, which is coupled to the suction part and is supported on the first sliding member so as to be slidable in the first direction relative to the first sliding member;
wherein the attachment main body and the first sliding member are configured so that a support position of the first sliding member is modifiable, in the first direction, by the attachment main body.

9. The vacuum-adhesion attachment according to claim 1, further comprising a filter, which is disposed in a suction path that fluidly connects the chamber and the vacuum pump.

10. The vacuum-adhesion attachment according to claim 9, wherein:
the valve is in fluid communication with the chamber via the suction path; and
the filter is disposed so that outside air, which flows into the chamber via the suction path in response to the valve being in an open state, passes through the filter.

11. A power-tool system, comprising:
a power tool; and
a vacuum-adhesion attachment;
wherein:
the power tool comprises:
a motor;
a tool main body, which houses the motor; and
a main switch configured to operate in response to manual manipulation thereof to start and stop driving of the motor; and
the vacuum-adhesion attachment comprises:
an attachment main body, which is mounted on the tool main body in a detachable manner;
a vacuum pump, which is housed in the attachment main body;
a suction part, which has a chamber in fluid communication with the vacuum pump and is configured to be adhered to a surface of a work material in response to the chamber being brought to a reduced pressure state by driving of the vacuum pump; and
a valve, which is in fluid communication with the chamber of the suction part, is normally in a closed state to block a flow of outside air into the chamber, and is configured to be switched, in response to manual manipulation by a user, to an open state that permits a flow of outside air into the chamber.

12. The power-tool system according to claim 11, wherein:
the power tool comprises a first terminal part;
the vacuum-adhesion attachment comprises a second terminal part;
the first terminal part and the second terminal part are configured to be electrically connected to each other when the attachment main body is mounted on the tool main body; and
the vacuum pump is configured to be driven by the electric power supplied from the power tool via the first terminal part and the second terminal part.

13. The power-tool system according to claim 11, further comprising a control apparatus configured to control the operation of at least one of the power tool and the vacuum-adhesion attachment in accordance with the state of the power-tool system.

14. The power-tool system according to claim 13, wherein the control apparatus is configured to start driving of the vacuum pump in response to the main switch of the power tool being turned ON.

15. The power-tool system according to claim 14, wherein the control apparatus is configured to start driving of the vacuum pump in response to the main switch of the power tool being turned ON and to start driving of the motor of the power tool after a prescribed time has elapsed since the start of the driving of the vacuum pump.

16. The power-tool system according to claim 13, wherein:
the vacuum-adhesion attachment further comprises a pressure sensor configured to measure the pressure in the chamber of the suction part or the pressure in the interior of a suction path that fluidly connects the chamber and the vacuum pump; and
the control apparatus is configured to control the operation of at least one of the power tool and the vacuum-adhesion attachment based on the pressure measured by the pressure sensor.

17. The power-tool system according to claim 16, wherein the control apparatus is configured to start driving of the vacuum pump in response to the main switch of the power tool being turned ON and to start driving of the motor of the power tool in response to the pressure measured by the pressure sensor falling below a first threshold.

18. The power-tool system according to claim 16, wherein the control apparatus is configured to stop driving of the vacuum pump in response to the pressure falling below the first threshold during driving of the pump and thereafter to resume driving of the vacuum pump in response to the pressure exceeding a second threshold, which is greater than the first threshold.

19. The power-tool system according to claim 18, wherein the control apparatus is configured to stop driving of the motor of the power tool in response to: (i) the measured pressure exceeding the second threshold for a prescribed time or (i) the measured pressure exceeding the second threshold for a prescribed count within a prescribed time period.

20. The power-tool system according to claim 11, wherein:
the power tool is a drill tool configured to rotationally drive a tool accessory around a drive axis; and
the vacuum-adhesion attachment further comprises a sliding part, which is coupled to the suction part and is supported on the attachment main body so as to be slidable in a first direction, which is parallel to the drive axis, relative to the attachment main body.
